(19) United States
(12) Patent Application Publication
(10) Pub. No.: US 2012/0230425 A1
(43) Pub. Date: Sep. 13, 2012

(54) ENCODING APPARATUS AND METHOD OF CONVERSION BLOCK FOR INCREASING VIDEO COMPRESSION EFFICIENCY

(75) Inventors: Ju-Heon Seo, Seoul (KR); Seong-Hoon Kim, Seoul (KR); In-Kwon Kim, Gwangmyeong-si (KR); Seung-Hoon Jung, Seoul (KR)

(73) Assignee: GALAXIA COMMUNICATIONS CO., LTD.,, Seoul (KR)

(21) Appl. No.: 13/508,585

(22) PCT Filed: Nov. 10, 2010
(86) PCT No.: PCT/KR2010/007895

§ 371 Date: May 8, 2012

(30) Foreign Application Priority Data
Nov. 10, 2009 (KR) 10-2009-0108105

(51) Int. Cl. H04N 7/24

(52) U.S. Cl. 375/240.24; 375/E07.026

(57) ABSTRACT

A compression encoding method which, when performing data conversion using the fact that when data is converted into frequency components, the human eye is sensitive to components close to low frequency components and insensitive to components close to high frequency components, configures a filter in which importance is placed on DC data and its adjacent filter coefficients, calculates the cost for a conversion block which has undergone conversion and quantization, which is required for the data removal of compression encoding using the filter, determines data targets to be removed using the calculated cost and set reference values, and removes the corresponding data, thereby reducing the amount of data to be compressed and therefore increasing compression efficiency without influencing image quality.

### TECHNICAL FIELD

The present invention relates to a method for increasing video compression efficiency in a video encoder using block-based conversion, and, more particularly, to a apparatus and method which calculate the costs for the setting of targets to be removed by applying a filter to a conversion block which has undergone a conversion process and remove data after comparing the costs with set reference values, thereby reducing the number of bits generated and therefore increasing the compression efficiency of a video encoder.

### BACKGROUND ART

In general, a video encoder to which a method for removing temporal redundancy has been applied, as shown in FIG. 1, includes:

a subtracter 10 for obtaining residual data between block-based input data and prediction data created by a prediction unit and converting the residual data obtained by the subtracter 10 into a predetermined function, a conversion and quantization unit 20 for quantizing resulting data, an entropy encoding unit 30 for again losslessly compressing the quantized and converted data and outputting the data in the form of a bit stream, and a prediction unit 40 for creating reconstructed data using the quantized and converted data and utilizing the data as reference data.

The prediction unit 40 includes an inverse conversion and inverse quantization unit 41 for inversely quantizing the converted data quantized by the conversion and quantization unit 20 and inversely converting the converted data, an adder 42 for creating the reconstructed data using the decoded data, a frame memory 43 for storing the reconstructed data and the reference data, a motion prediction unit 44 for creating a motion vector by predicting the motion of the input data from the reference data, and a motion compensation unit 45 for compensating for the motion using the motion vector created by the motion prediction unit 44.

In general, the video encoder for removing temporal redundancy predicts a motion using currently input data and previously stored reference data, and sequentially performs conversion, quantization, and entropy encoding on residual data, thereby increasing compression efficiency.

The quantized and converted data before entropy encoding is converted into reconstructed data via inverse conversion and inverse quantization, and the reconstructed data is used as reference data.

Furthermore, when the video encoder is an H.264/AVC encoder, a deblocking filter is used so as to reduce a block distortion phenomenon after an inverse conversion and inverse quantization unit.

Conversion and quantization is a technology that divides input data into low frequency components and high frequency components and also uses representations utilizing discrete values using the fact that the visual characteristics of the human eye are sensitive to low frequency components and insensitive to high frequency components, thereby reducing the number of bits, as shown in FIG. 4.

The quantized and converted data include DC coefficients located on the upper left side and AC coefficients other than the DC coefficients.

Here, the converted data probabilistically has a value of 0 or a value near 0.

In general, in a conventional video encoder, converted data used in entropy encoding has bits allocated to portions which do not relatively greatly influence subjective image quality. Accordingly, when entropy encoding is performed on such converted data without change, the bit rate is increased in terms of the number of bits generated, so that the video compression efficiency is decreased.

### DISCLOSURE

### Technical Problem

Accordingly, the present invention is intended to propose a compression encoding method which, when performing data conversion using the fact that when data is converted into frequency components, the human eye is sensitive to components close to low frequency components and insensitive to components close to high frequency components, configures a filter in which importance is placed on DC data and its adjacent filter coefficients, calculates the cost for a conversion block which has undergone conversion and quantization, which is required for the data removal of compression encoding using the filter, determines data targets to be removed using the calculated cost and set reference values, and removes the corresponding data, thereby reducing the amount of data to be compressed and therefore increasing compression efficiency without influencing image quality.

### Technical Solution

The present invention provides a conversion block encoding apparatus for increasing video compressing efficiency,

the apparatus being a video encoder for compressing video by removing temporal redundancy, the apparatus including:

a data filter unit for removing set basic blocks by determining a quantized conversion block and applying a filter having an identical size to that of the conversion block, removing data of the basic blocks (converting the data into 0) depending on distribution of data of a macroblock including the one or more basic blocks, and providing it as data which is a target for compression of an encoding process to be output in a form of a bit stream,

the data filter unit comprises a conversion filter application unit for receiving the conversion block transferred after the conversion and quantization process, determining a size of the conversion block, and calculating a cost by applying a filter having an identical size to that of the conversion block, a basic block determination unit for determining whether to remove the basic blocks using the cost for the basic blocks calculated by the conversion filter application unit, a conversion block removal reference value set based on an applied filter coefficient and a block size value related to a size of data, a macro-block determination unit for determining whether to remove the basic blocks within the macro-block using costs for the basic blocks of the macro-block calculated by the conversion filter application unit, a basic block removal reference value set based on the applied filter, and a block size value related to a size of data, and determining whether to remove the macro-block by comparing the sum of the costs for the basic blocks with a macro-block removal reference value set based on the applied filter, and a block removal unit for removing data of the blocks determined by the basic block determination unit and the macro-block determination unit.

The present invention provides a conversion block encoding method for increasing video compressing efficiency, the method being a video encoding process for compressing video by removing temporal redundancy, the method including:

a basic block cost calculation process of calculating a cost for a conversion block by determining a size of each block obtained via a conversion and quantization process and applying a filter having an identical size to the determined size; a basic block determination process of determining whether to remove the basic block by comparing the cost for the basic block, calculated via the basic block cost calculation process, with a conversion block removal reference value, and then determining whether data within the basic block is equal to or less than a block size value, and determining the basic block to be removed; a macro-block determination process of determining whether the basic block within the macro-block is a target to be removed by comparing the cost for each basic block within the macro-block with a basic block removal reference value and comparing a size of data within the block with the block size value, and if, as a result of the determination, the basic block is a target, determining whether to remove the macro-block by comparing a sum of basic blocks within the macro-block with a macro-block removal reference value; and a block removal process of removing the block based on results of the basic block determination process and the macro-block determination process and providing compression data for the encoding process.

### ADVANTAGEOUS EFFECTS

According to the present invention, a current video encoder removes portions to which the human eye is insensitive, thereby efficiently reducing the number of bits generated while minimizing influence on image quality and therefore increasing the compression efficiency of the video encoder.

The present invention provides a method and apparatus that are not limited to H.264/AVC, which was taken as an example above, but can be applied to all video encoders which remove temporal redundancy and perform conversion.

### DESCRIPTION OF DRAWINGS

FIG. 1 is a block diagram showing the configuration of an image encoder for removing general temporal redundancy;

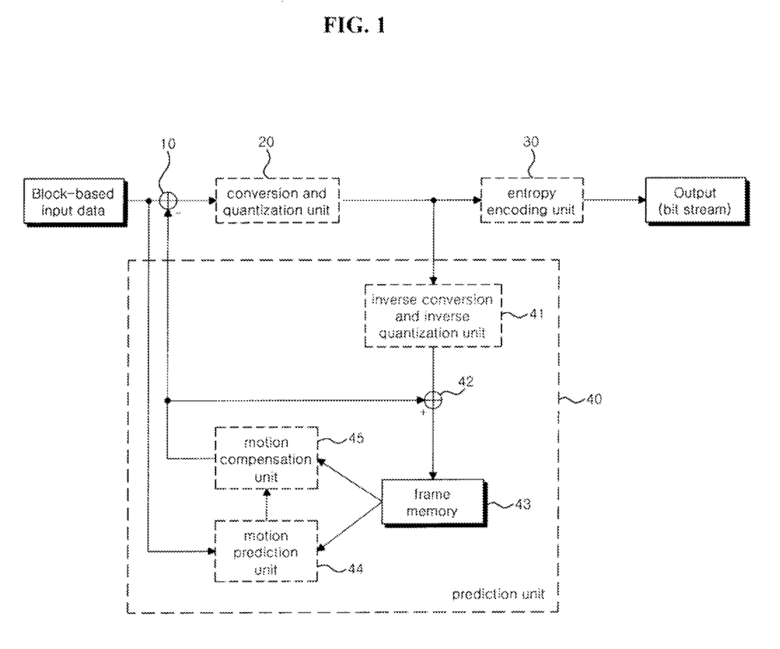

FIG. 2 is a block diagram showing the configuration of an apparatus for encoding a conversion block for the purpose of increasing video compression efficiency according to the present invention;

FIG. 3 is a block diagram showing the detailed configuration of a data filter unit according to the present invention;

FIG. 4 is a diagram showing the characteristics of conversion block data which has undergone conversion and quantization;

FIG. 5 is a diagram showing embodiments of filters which are applied to a conversion block in a case (a) where an encoding method is frame encoding and in a case (b) where an encoding method is field encoding in the present invention;

FIG. 6 is a diagram showing the macro-block and lower blocks of H.264/AVC;

FIG. 7 is a diagram illustrating a process of calculating cost by applying a filter (b) to a conversion block (a) in the case where an encoding method is frame encoding and a filter (c) to a conversion block (a) in the case where an encoding method is field encoding in the present invention;

FIG. 8 is a diagram showing an embodiment of a macroblock including basic blocks in the present invention;

FIG. 9 is a diagram showing embodiments of encoding a frame encoding filter (a) and a field encoding filter (b) which are applied to a 8×8 conversion block in accordance with an encoding method in the present invention; and

FIG. 10 is a flowchart showing a process of removing data in a conversion block encoding method for increasing video compressing efficiency according to the present invention.

### MODE FOR INVENTION

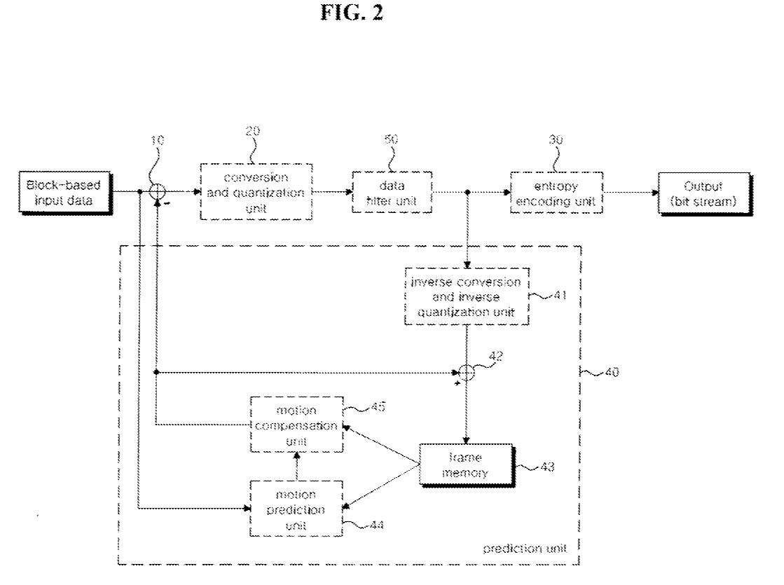

An apparatus for encoding a conversion block for the purpose of increasing video compression efficiency according to the present invention will be described below with reference to the embodiment of FIG. 2, with the same reference characters given to the same or like components.

The apparatus includes a subtracter 10 for obtaining residual data between block-based input data and prediction data created by a prediction unit, a conversion and quantization unit 20 for converting the residual data obtained by the subtracter 10 into a predetermined function and quantizing the resulting data,

a data filter unit 50 for removing set basic blocks by applying a filter to a quantized conversion block output from the conversion and quantization unit 20 and removing the data of the basic blocks (converting the data into 0) based on the distribution of data of one or more macroblocks, an entropy encoding unit 30 for losslessly compressing quantized and converted data output via the filter unit 50 again and outputting the compressed data in the form of a bit stream, and a prediction unit 40 for creating reconstructed data using the quantized and converted data output via the data filter unit 50 and utilizing it as reference data reference data.

The prediction unit 40 includes an inverse conversion and inverse quantization unit 41 for inversely quantizing the quantized and converted data output via the data filter unit 50 and inversely converting the converted data, an adder 42 for creating reconstructed data using the decoded data, a frame memory 43 for storing the reconstructed data and the reference data, a motion prediction unit 44 for creating a motion vector by predicting the motion of the input data from the reference data, and a motion compensation unit 45 for compensating for the motion using the motion vector created by the motion prediction unit 44.

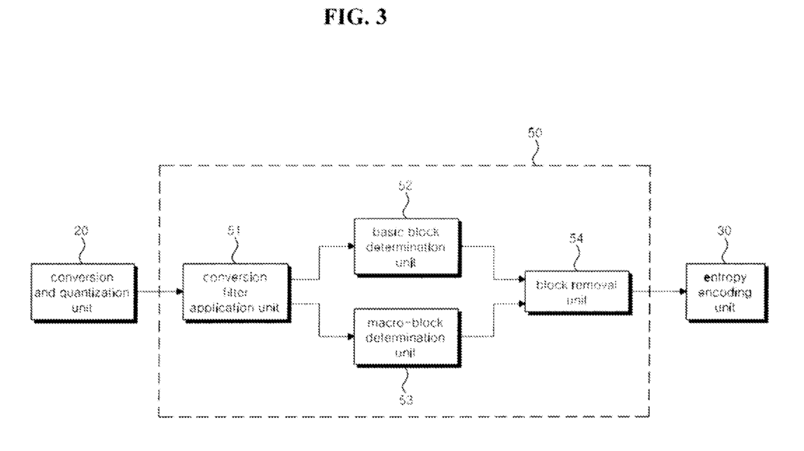

The data filter unit 50, as shown in FIG. 3, includes a conversion filter application unit 51 for receiving a conversion block including the quantized and converted data output from the conversion and quantization unit 20, determining the size of the conversion block, and calculating a cost by applying a filter which is selected from among filters set based on encoding methods and corresponds to the size of the set conversion block, a basic block determination unit 52 for determining whether to remove basic blocks using the cost calculated by the conversion filter application unit 51, a conversion block removal reference value set based on an applied filter coefficient and a block size value related to the size of data, a macro-block determination unit 53 for determining whether to remove basic blocks within a macro-block using costs for the basic blocks of the macro-block calculated by the conversion filter application unit 51, a basic block removal reference value set based on the applied filter and a block size value related to the size of data and determining whether to remove the macro-block by comparing the sum of the costs for the basic blocks with a macroblock removal reference value set based on the applied filter, and a block removal unit 54 for removing the data of the blocks determined by the basic block determination unit 52 and the macro-block determination unit 53.

In the above-described apparatus for encoding a conversion block for the purpose of increasing video compression efficiency according to the present invention,

the conversion and quantization unit 20 is means which converts and quantizes the residual data obtained by the prediction unit 40 by performing prediction and outputs a conversion block including the quantized conversion coefficients.

The prediction unit 40 is means which predicts currently input data using the reference data inversely converted and inversely quantized and then stored in frame memory.

The data filter unit 50 is means which removes the data of blocks by applying a filter having an identical size to the conversion block of the conversion and quantization unit 20 and converting it into 0. The data filter unit 50 converts the data of the blocks into 0 based on the distribution of the data of the quantized conversion block output from the conversion and quantization unit 20, and the distribution of the data of one or more macroblocks, and outputs them.

The entropy encoding unit 40 performs encoding on the data of the blocks output from the data filter unit 50 in accordance with an entropy encoding mode, and outputs a bit stream.

In the data filter unit 50,

the conversion filter application unit 51 is means which receives the conversion block including the quantized and converted data output from the conversion and quantization unit 20, determines the size of the conversion block, and calculates a cost by applying a filter having an identical size to that of the conversion block to the data of the conversion block.

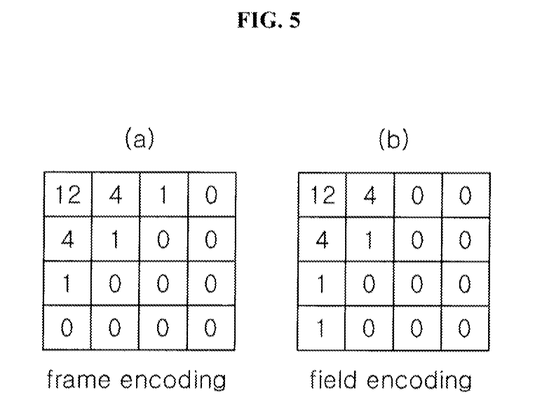

The conversion filter application unit 51 calculates a cost by applying a frame encoding filter (a) set in accordance with an encoding method, that is, frame encoding, and a field encoding filter (b) set in accordance with field encoding, as shown in FIG. 5.

The basic block determination unit 52 is means which determine whether to remove data within the set basic blocks using the cost calculated by the conversion filter application unit 51. The basic block determination unit 52 determines whether to remove the basic blocks using the conversion block removal reference value set based on the applied filter coefficient and a block size value related to the size of data.

The conversion block removal reference value is formed of the largest filter coefficient applied to the conversion block, which means that that the filter coefficient applied to DC data is applied.

The block size value is set to “1.”

The fact that the block size value is set to 1 and data equal to or smaller than 1 is removed means that the conversion of block data refers to the conversion of the data into frequency components and data converted into the frequency domain and having size values equal to or larger than 2 is not removed because it highly influences blocks which have undergone inversion conversion at the prediction unit 40 in one or more regions.

If the calculated cost is equal to or lower than the set conversion block removal reference value and the data of the conversion block is equal to or lower than a set block size value of 1, the basic blocks are determined to be removed.

The macro-block determination unit 53 is means which determines whether to remove a macro-block including set one or more basic blocks. The macro-block determination unit 53 determines whether to remove the basic blocks within the macro-block using the costs for the basic blocks of the macro-block calculated by the conversion filter application unit 51, the block removal reference value set based on the applied filter, and the block size value related to the size of data, and determines whether to remove the macro-block by comparing the sum of the costs for the basic blocks with the macro-block removal reference value set based on the applied filter.

The block removal reference value is formed of the sum of a largest filter coefficient value, that is, a coefficient value applied to DC data, and the smallest coefficient value, and the macro-block removal reference value is set to the sum of the largest cost for two or less DC coefficients, to which the largest filter coefficient has been applied, and the smallest coefficient.

The macro-block determination unit 53, if the cost for the basic blocks of the macro-block calculated by the conversion filter application unit 51 is equal to or lower than the block removal reference value, and the data of the basic blocks is equal to or lower than the block size value “1,” determines whether to remove a macro-block by comparing the macro-block removal reference value with the sum of the costs for the reference blocks.

If the cost for the basic blocks of the macro-block calculated by the conversion filter application unit 51 is equal to or lower than the macro-block removal reference value, the data within the macro-block is determined to be removed.

The block removal unit 54 removes the data by converting the data of the basic blocks which are determined to be removed by the basic block determination unit 52, and the data, which is determined to be removed by the macro-block determination unit 53, into 0.

In general, in H.264/AVC, basic 16×16 blocks called macro-blocks are included, and conversion is performed on a 4×4 block basis.

The conversion block includes conversion coefficients including one DC coefficient and 15 AC coefficients.

The operation of the above-described present invention will be described in detail with reference to the embodiments shown in the accompanying drawings.

The present embodiment illustrates an example to which the present invention has been applied and in which 8×8 blocks in H.264/AVC are used as basic blocks and higher blocks are 16×16 blocks called macro-blocks, in order to describe the present invention in detail.

When a conversion block is input to the data filter unit 50 via the conversion and quantization unit 20, the data filter unit 50 calculates the cost by applying a filter having an identical size to that of the conversion block.

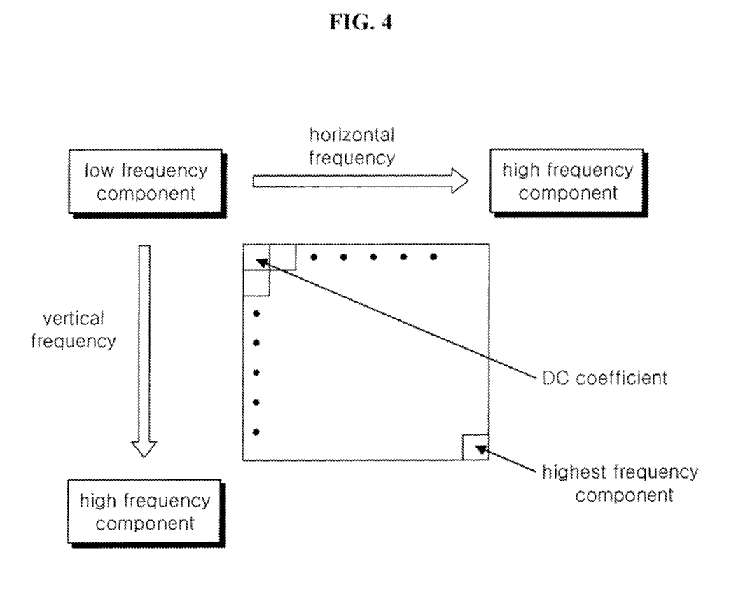

Referring to FIG. 4, using the fact that the human eye is sensitive to low frequency components and insensitive to high frequency components, the filter to be applied to the converted block is configured such that it has a large coefficient for low frequency components and a small coefficient for high frequency components, as shown in FIG. 5.

As shown in FIG. 5, when conversion is performed on a 4×4 block basis, the filter includes the values of coefficients at three steps, as shown in Equation 1:

(N×N) filter step=N/4+2=3

The sum of 1's which are the smallest coefficients, should be smaller than 4, which is the next smallest coefficient, and 12, which is the largest coefficient, should be larger than the sum of the other coefficients.

In this case, the data filter unit 50 calculates the cost using a different filter depending on the encoding method, as shown in FIG. 5.

When encoding is initiated in the system, the encoding method is determined. As information about the encoding method is transferred to each device block, the data filter unit 50 selects a filter set in accordance with information about the encoding method, that is, a frame method or, a field method.

As described above, in H.264/AVC, conversion is performed on a 4×4 block basis, and therefore a conversion block obtained and output by the conversion and quantization unit 20 has a 4×4 size. As shown in FIG. 5, a frame encoding filter (a) and a field encoding filter (b) having an identical size to that of the conversion block are formed in accordance with the encoding method.

The filters may be configured after taking into consideration the importance of the scan sequence regarding the frame encoding method and the field encoding method, as shown in FIGS. 5a and 5b.

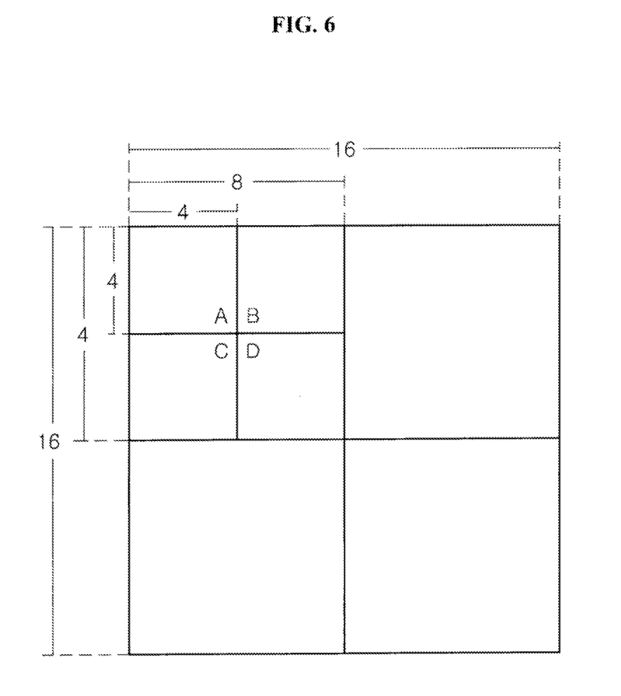

In the present embodiment, the basic blocks are 8×8 blocks and the encoding method is a frame encoding method. Since the cost can be calculated using a frame encoding filter (a) such as that used by the conversion filter application unit 51, as shown in FIG. 5, and the cost for an 8×8 basic block can be obtained by adding the costs for 4×4 blocks, as shown in FIG. 6, the cost for the 8×8 basic block is calculated by adding the costs for the 4×4 blocks within the 8×8 basic block, as described above.

Thereafter, the basic block determination unit 52 determines whether to remove basic blocks by comparing the cost for an 8×8 basic block obtained as described above with the conversion block removal reference value set based on the DC data coefficient value of the filter and comparing the size of data with the block size value.

The conversion block removal reference value is 12, as shown in FIG. 5, and the block size value is 1, as described above.

In the basic block determination unit 52, the conversion block removal reference value is equal to or smaller than 12. When the value of data is equal to or smaller than the block size value 1, the basic blocks are determined to be removed.

Furthermore, the macro-block determination unit 53 performs a data removal process on a macro-block basis when removing basic blocks. Whether to remove one or more basic blocks which have not been removed in the basic block removal process is again determined within the macro-block which is higher than the basic blocks.

The process of removing data in a 16×16 macro-block including four 8×8 blocks is performed in the sequence described as follows:

(a) comparison between the cost for each 8×8 basic block and a basic block removal reference value;

(b) comparison between the size of data within each 8×8 basic block and a block size value; and

(c) comparison between the sum of costs for respective 8×8 basic blocks and a macro-block removal reference value.

Although the basic block removal reference value is a value based on the filter, like the conversion block removal reference value, it is 15, which is the value set by adding the sum of the smallest coefficient values to the largest coefficient value 12 after the macro-block has been taken into consideration.

As described above, the block size value is “1.”

Furthermore, the macro-block removal reference value is set to 27, which is obtained by adding the maximum cost 24 (12×2) and the sum of the smallest coefficients, that is, 3, so that the number of DC coefficients to which the largest coefficient has been applied is 2 or less.

The macro-block removal reference value is set as described above so that the number of pieces of DC data can be limited to two or less. The reason for this is that the removal of two or less pieces of DC data does not cause a problem, and image quality may be influenced when the macro-block is removed if there are two or more pieces of DC data.

The macro-block determination unit 53 determines that it will remove the macro-block if each basic block within the macro-block is equal to or less than 15, the block size of data is equal to or less than 1, and the value obtained by adding the costs for respective basic blocks within the macro-block is equal to or less than the macro-block removal reference value 27.

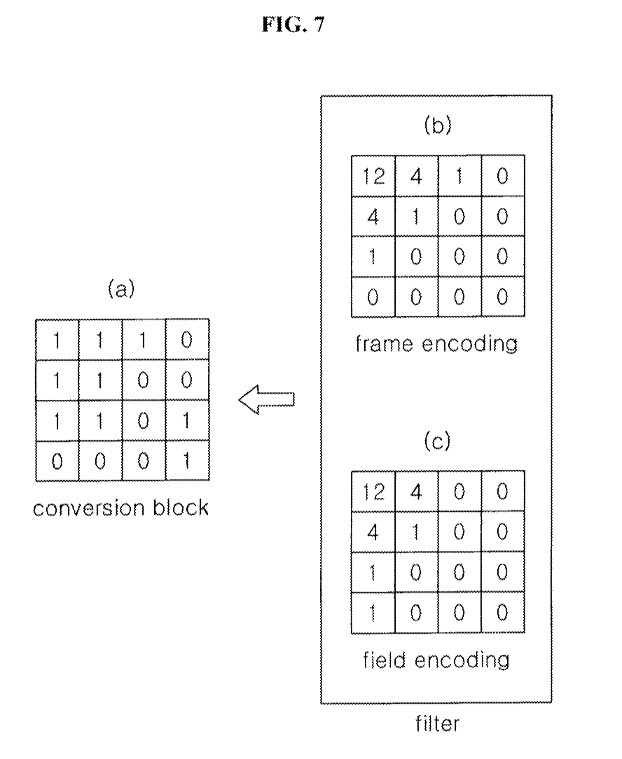

FIG. 7 is a diagram illustrating the process of calculating the costs by applying the filter (b) to the conversion block (a).

As shown in FIG. 7, when conversion block data, such as that in (a), is input from the conversion and quantization unit 20, the conversion filter application unit 51 calculates the cost by applying a filter having the same size, such as that shown in (b), as shown in Equation 2.

Cost=(1×12)+(1×4)+(1×4)+(1×1)+(1×1)+(1×1)+(1TIME0)+(1TIME0)+(1×0)=23 (2)

Thereafter, when the cost is calculated for conversion blocks A, B, C, and D, as shown in FIG. 5, and the cost is compared with the conversion block removal reference value 12, the cost is larger than the conversion block removal reference value, so that removal is not performed.

When one 4×4 conversion block is not removed, a basic block is not removed even when the corresponding basic block includes one basic block. As described above, this means that a conversion block adjacent to DC data is data adjacent to important data and cannot be a target to be removed.

Accordingly, design may be performed to exclude a basic block in which a conversion block is included from targets to be removed without calculating the cost for an adjacent conversion block in the case where the corresponding conversion block has a cost which is larger than the conversion block removal reference value 12.

Thereafter, whether the basic blocks within the macro-block are targets to be removed is primarily determined by comparing the cost for each of 8×8 basic blocks A, B, C, and D within the 16×16 macro-block with the basic block removal reference value 15.

Since the basic block A is currently 23, a basic block including blocks A, B, C, and D is equal to or larger than 23. When this is taken as an example, it becomes larger than 15, so that it is not a target to be removed.

Accordingly, a macro-block is not removed as a whole.

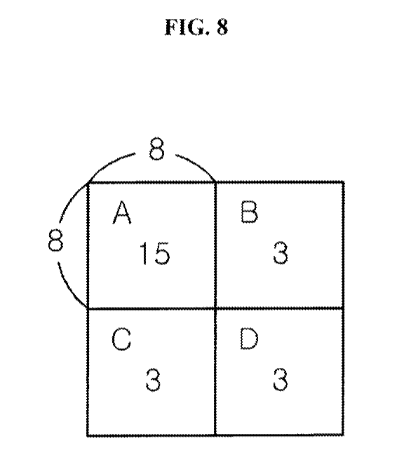

However, when basic blocks are configured as shown in FIG. 8, the cost for each reference block is 15 for the A basic block, 3 for the B basic block, 3 for the C basic block, and 3 for the D basic block. In the basic block removal determination process, when compared with the basic block removal reference value 12, the B, C, and D basic blocks are targets to be removed and are therefore removed, but the A basic block is not a target to be removed.

In this case, in the macro-block removal determination process, since the A basic blocks are smaller than the basic block removal reference value 15, data is equal to or smaller than 1, the sum of the costs for the respective basic blocks A, B, C, and D is 24, the corresponding macro-block of FIG. 8 is a target to be removed when it is compared with the macro-block removal reference value 27, and the A basic block is also a target to be removed.

Accordingly, since the basic block determination unit 52 determines that it will remove the B, C, and D basic blocks and the macro-block determination unit 53 determines that it will remove the macro-block including the B, C, D, and A basic blocks, the block removal unit 54 will remove all of the A, B, C, and D basic blocks.

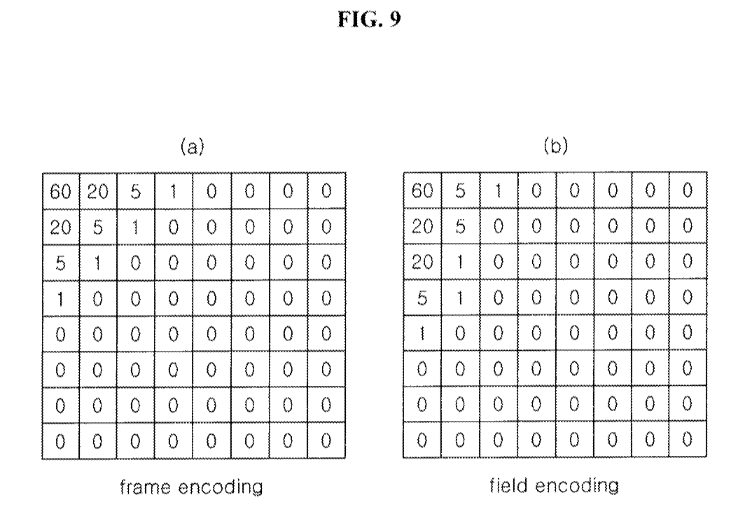

Meanwhile, in the present embodiment, H.264/AVC is taken as an example and a 4×4 conversion block is taken as an example. In another example, when conversion is performed on an 8×8 block basis, the filter (a) is configured in the case where the encoding method is frame encoding and the filter (b) is configured in the case where the encoding method is field encoding, in accordance with the size of a conversion block, as shown in FIG. 9 in which four step coefficients obtained using Equation 1 are included.

Furthermore, although the macro-block is configured using the basic 16×16 block, it may be configured using a 32×32 block or a 64×64 block in other examples, in which case 8×8 basic blocks can be arranged as basic blocks and data can be removed as described above.

Furthermore, the system may be designed such that the conversion block is set to be the basic block.

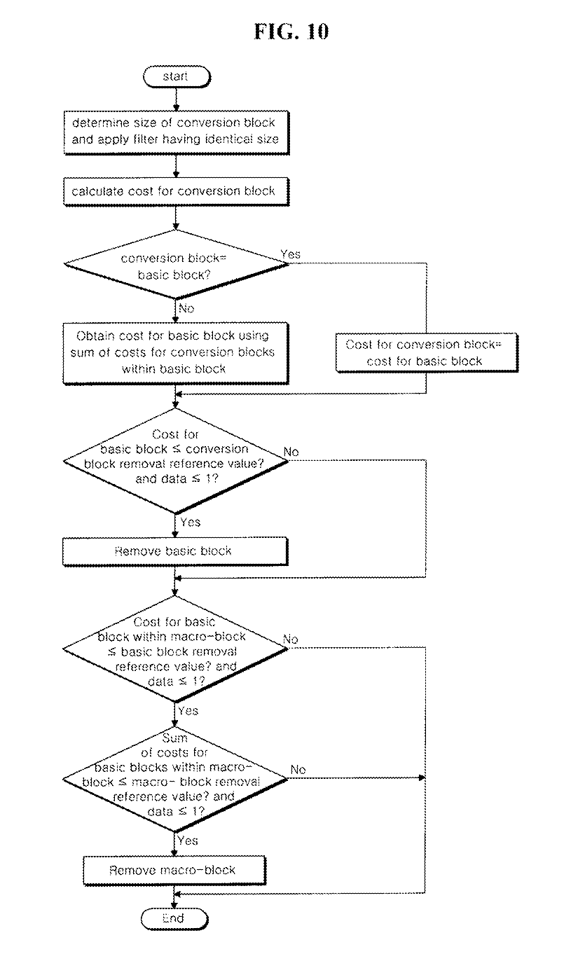

Meanwhile, FIG. 10 shows a process of removing data in compression encoding according to the present invention in a flowchart.

The process includes a basic block cost calculation process of calculating a cost for a conversion block by determining the size of each block obtained via a conversion and quantization process and applying a filter having an identical size to the determined size,

a basic block determination process of determining whether to remove the basic block by comparing the cost for the basic block, calculated via the basic block cost calculation process, with a conversion block removal reference value and then determining whether data within the basic block is equal to or less than the block size value 1, and determining the basic block to be removed,

a macro-block determination process of determining whether the basic block within the macro-block is a target to be removed by comparing the cost for each basic block within a macro-block with a basic block removal reference value and determining whether the size of data within the block is equal to or less than the block size value 1, and if, as a result of the determination, the basic block is a target, determining whether to remove the macro-block by comparing a sum of basic blocks within the macro-block with a macro-block removal reference value, and

a block removal process of removing the block based on results of the basic block determination process and the macro-block determination process. The cost calculation process includes the step of determining whether the conversion block is identical to the set basic block by comparing the size of the conversion block with the size of the set basic block, and the step of, if the size of the conversion block is identical to that of the set basic block, using the cost for the conversion block as the cost for the basic block without change, and if the conversion block is different from the set basic block, calculating the cost for the basic block by adding the costs for conversion blocks within the basic block.

1. A conversion block encoding apparatus for increasing video compressing efficiency, the apparatus being a video encoder for compressing video by removing temporal redundancy, the apparatus comprising:
a data filter unit removing set basic blocks by determining a quantized conversion block and applying a filter having an identical size to that of the conversion block, removing data of the basic blocks (converting the data into 0) depending on distribution of data of a macro-block including the one or more basic blocks, and providing it as data which is a target for compression of an encoding process to be output in a form of a bit stream.

2. The conversion block encoding apparatus of claim 1, wherein the data filter unit comprises a conversion filter application unit for receiving the conversion block transferred after the conversion and quantization process, determining a size of the conversion block, and calculating a cost by applying a filter having an identical size to that of the conversion block, a basic block determination unit for determining whether to remove the basic blocks using the cost for the basic blocks calculated by the conversion filter application unit, a conversion block removal reference value set based on an applied filter coefficient and a block size value related to a size of data, a macro-block determination unit for determining whether to remove the basic blocks within the macro-block using costs for the basic blocks of the macro-block calculated by the conversion filter application unit, a basic block removal reference value set based on the applied filter, and a block size value related to a size of data, and determining whether to remove the macro-block by comparing the sum of the costs for the basic blocks with a macro-block removal reference value set based on the applied filter, and a block removal unit for removing data of the blocks determined by the basic block determination unit and the macro-block determination unit.

3. The conversion block encoding apparatus of claim 2, wherein the basic block determination unit sets the data of the basic block to a target to be removed if the cost calculated by the conversion filter application unit is equal to or smaller than the conversion block removal reference value and the size of the data is equal to or smaller than the block size value; and
the macro-block determination unit determines whether the basic blocks within the macro-block are targets to be removed if the cost calculated by the conversion filter application unit is equal to or smaller than the basic block removal reference value and the size of the data is equal to or smaller than the block size value, and determines that the macro-block will be removed if it is determined that the basic blocks within the macro-block are targets to be removed and a sum of the costs for the basic blocks is equal to or smaller than the macro-block removal reference value.

4. The conversion block encoding apparatus of claim 2, wherein the conversion block application unit configures a frame encoding filter and a field encoding filter to be applied to the conversion block in order to calculate the cost, and selectively applies the frame encoding filter and the field encoding filter in accordance with an encoding method.

5. The conversion block encoding apparatus of claim 1, wherein the filter coefficient of the filter to be applied to the conversion block is set based on an importance location of the data, the set filter coefficient includes a filter step value set based on the size (N×N) of the conversion block, and a sum of largest coefficients is set to a value smaller than a next smallest coefficient and a largest coefficient is set to a value larger than a sum of other coefficients.

6. The conversion block encoding apparatus of claim 5, wherein the filter step value determined based on the size of the conversion block (N×N) is set by N/4+2.

7. The conversion block encoding apparatus of claim 2, wherein the conversion block removal reference value is set to a largest coefficient value of the filter to be applied to the conversion block.

8. The conversion block encoding apparatus of claim 2, wherein the block size value related to the size of the data is set to 1.

9. The conversion block encoding apparatus of claim 2, wherein the basic block removal reference value is a value which is used to determine whether to remove the basic blocks within the macro-block, and is a value which is set by adding a sum of smallest coefficient values of the applied filter to a largest coefficient value.

10. The conversion block encoding apparatus of claim 2, wherein the macro-block removal reference value is set to a value obtained by adding a sum of smallest coefficients to a maximum cost for a largest coefficient (largest coefficient×2), in order to perform removal up to a case where there are two or less DC coefficients to which the largest coefficient has been applied.

11. The conversion block encoding apparatus of claim 2, wherein the conversion filter application unit determines whether the conversion block is identical to the set basic block by comparing the size of the conversion block with the size of the set basic block, and determines that the cost for the conversion block is the cost for the basic block without change if the conversion block is identical to the set basic block and calculates the cost for the basic block by adding the costs for conversion blocks within the basic block if the conversion block is different from the set basic block.

12. A conversion block encoding method for increasing video compressing efficiency, the method being a video encoding process for compressing video by removing temporal redundancy, the method comprising:
a basic block cost calculation process of calculating a cost for a conversion block by determining a size of each block obtained via a conversion and quantization process and applying a filter having an identical size to the determined size;
a basic block determination process of determining whether to remove the basic block by comparing the cost for the basic block, calculated via the basic block cost calculation process, with a conversion block removal reference value, and then determining whether data within the basic block is equal to or less than a block size value, and determining the basic block to be removed;
a macro-block determination process of determining whether the basic block within the macro-block is a target to be removed by comparing the cost for each basic block within the macro-block with a basic block removal reference value and comparing a size of data within the block with the block size value, and if, as a result of the determination, the basic block is a target, determining whether to remove the macro-block by comparing a sum of basic blocks within the macro-block with a macro-block removal reference value; and
a block removal process of removing the block based on results of the basic block determination process and the macro-block determination process and providing compression data for the encoding process.

13. The conversion block encoding method of claim 12, wherein the basic block cost calculation process further comprises the step of applying a filter in accordance with an encoding method when selecting the filter having an identical size to the size of the conversion block in order to calculate the cost.

14. The conversion block encoding method of claim 12, wherein the cost calculation process comprises the step of determining whether the conversion block is identical to the set basic block by comparing the size of the conversion block with the size of the set basic block, and the step of using the cost for the conversion block as the cost for the basic block without change if the conversion block is identical to the set basic block and calculating the cost for the basic block by adding the costs for conversion blocks within the basic block if the conversion block is different from the set basic block.

15. The conversion block encoding method of claim 12, wherein the basic block determination process sets the data of the basic blocks to a target to be removed if the cost for the basic block calculated in the basic block cost calculation process is equal to or smaller that the conversion block removal reference value and the size of the data is equal to or smaller than the block size value; and
the macro-block determination process determines whether the basic blocks within the macro-block are targets to be removed if the cost for the basic block calculated in the basic block cost calculation process is equal to or smaller than the basic block removal reference value and the size of the data is equal to or smaller than the block size value, and determines that the macro-block will be removed if it is determined that the basic blocks within the macroblock are targets to be removed and the sum of the costs for the basic blocks is equal to or smaller than the macro-block removal reference value.

16. The conversion block encoding method of claim 12, wherein the filter coefficient of the filter to be applied to the conversion block in the basic block cost calculation process is set based on an importance location of the data, the set filter coefficient includes a filter step value set based on the size of the conversion block, and a sum of largest coefficients should be set to a smaller value than a next smallest coefficient and a largest coefficient is set to a larger value than a sum of other coefficients.

17. The conversion block encoding method of claim 12, wherein the conversion block removal reference value in the basic block determination process is set to a largest coefficient value of the filter to be applied to the conversion block.

18. The conversion block encoding method of claim 12, wherein the block size value related to the size of the data in the basic block determination process and the macro-block determination process is set to 1.

19. The conversion block encoding method of claim 12, wherein the basic block removal reference value in the macro-block determination process is a value which is used to determine whether to remove the basic blocks within the macro-block, and is a value which is set by adding of a sum of smallest coefficient values of the applied filter to a largest coefficient value.

20. The conversion block encoding method of claim 12, wherein the macro-block removal reference value in the macro-block determination process is set to a value obtained by adding a sum of smallest coefficients to a maximum cost for a largest coefficient (largest coefficient×2), in order to perform removal up to a case where there are two or less DC coefficients to which the largest coefficient has been applied.

21. The conversion block encoding apparatus of claim 2, wherein the filter coefficient of the filter to be applied to the conversion block is set based on an importance location of the data, the set filter coefficient includes a filter step value set based on the size (N×N) of the conversion block, and a sum of largest coefficients is set to a value smaller than a next smallest coefficient and a largest coefficient is set to a value larger than a sum of other coefficients.

22. The conversion block encoding apparatus of claim 3, wherein the filter coefficient of the filter to be applied to the conversion block is set based on an importance location of the data, the set filter coefficient includes a filter step value set based on the size (N×N) of the conversion block, and a sum of largest coefficients is set to a value smaller than a next smallest coefficient and a largest coefficient is set to a value larger than a sum of other coefficients.

23. The conversion block encoding apparatus of claim 4, wherein the filter coefficient of the filter to be applied to the conversion block is set based on an importance location of the data, the set filter coefficient includes a filter step value set based on the size (N×N) of the conversion block, and a sum of largest coefficients is set to a value smaller than a next smallest coefficient and a largest coefficient is set to a value larger than a sum of other coefficients.

24. The conversion block encoding apparatus of claim 21, wherein the filter step value determined based on the size of the conversion block (N×N) is set by N/4+2.

25. The conversion block encoding apparatus of claim 22, wherein the filter step value determined based on the size of the conversion block (N×N) is set by N/4+2.

26. The conversion block encoding apparatus of claim 23, wherein the filter step value determined based on the size of the conversion block (N×N) is set by N/4+2.

27. The conversion block encoding apparatus of claim 3, wherein the conversion block removal reference value is set to a largest coefficient value of the filter to be applied to the conversion block.

28. The conversion block encoding apparatus of claim 4, wherein the conversion block removal reference value is set to a largest coefficient value of the filter to be applied to the conversion block.

29. The conversion block encoding apparatus of claim 3, wherein the block size value related to the size of the data is set to 1.

30. The conversion block encoding apparatus of claim 4, wherein the block size value related to the size of the data is set to 1.

31. The conversion block encoding apparatus of claim 3, wherein the basic block removal reference value is a value which is used to determine whether to remove the basic blocks within the macro-block, and is a value which is set by adding a sum of smallest coefficient values of the applied filter to a largest coefficient value.

32. The conversion block encoding apparatus of claim 4, wherein the basic block removal reference value is a value which is used to determine whether to remove the basic blocks within the macro-block, and is a value which is set by adding a sum of smallest coefficient values of the applied filter to a largest coefficient value.

33. The conversion block encoding apparatus of claim 3, wherein the macroblock removal reference value is set to a value obtained by adding a sum of smallest coefficients to a maximum cost for a largest coefficient (largest coefficient×2), in order to perform removal up to a case where there are two or less DC coefficients to which the largest coefficient has been applied.

34. The conversion block encoding apparatus of claim 4, wherein the macroblock removal reference value is set to a value obtained by adding a sum of smallest coefficients to a maximum cost for a largest coefficient (largest coefficient×2), in order to perform removal up to a case where there are two or less DC coefficients to which the largest coefficient has been applied.

35. The conversion block encoding apparatus of claim 3, wherein the conversion filter application unit determines whether the conversion block is identical to the set basic block by comparing the size of the conversion block with the size of the set basic block, and determines that the cost for the conversion block is the cost for the basic block without change if the conversion block is identical to the set basic block and calculates the cost for the basic block by adding the costs for conversion blocks within the basic block if the conversion block is different from the set basic block.

36. The conversion block encoding method of claim 13, wherein the filter coefficient of the filter to be applied to the conversion block in the basic block cost calculation process is set based on an importance location of the data, the set filter coefficient includes a filter step value set based on the size of the conversion block, and a sum of largest coefficients should be set to a smaller value than a next smallest coefficient and a largest coefficient is set to a larger value than a sum of other coefficients.

37. The conversion block encoding method of claim 14, wherein the filter coefficient of the filter to be applied to the conversion block in the basic block cost calculation process is set based on an importance location of the data, the set filter coefficient includes a filter step value set based on the size of the conversion block, and a sum of largest coefficients should be set to a smaller value than a next smallest coefficient and a largest coefficient is set to a larger value than a sum of other coefficients.

38. The conversion block encoding method of claim 15, wherein the filter coefficient of the filter to be applied to the conversion block in the basic block cost calculation process is set based on an importance location of the data, the set filter coefficient includes a filter step value set based on the size of the conversion block, and a sum of largest coefficients should be set to a smaller value than a next smallest coefficient and a largest coefficient is set to a larger value than a sum of other coefficients.

39. The conversion block encoding method of claim 13, wherein the conversion block removal reference value in the basic block determination process is set to a largest coefficient value of the filter to be applied to the conversion block.

40. The conversion block encoding method of claim 14, wherein the conversion block removal reference value in the basic block determination process is set to a largest coefficient value of the filter to be applied to the conversion block.

41. The conversion block encoding method of claim 15, wherein the conversion block removal reference value in the basic block determination process is set to a largest coefficient value of the filter to be applied to the conversion block.

42. The conversion block encoding method of claim 13, wherein the block size value related to the size of the data in the basic block determination process and the macroblock determination process is set to 1.

43. The conversion block encoding method of claim 14, wherein the block size value related to the size of the data in the basic block determination process and the macroblock determination process is set to 1.

44. The conversion block encoding method of claim 15, wherein the block size value related to the size of the data in the basic block determination process and the macroblock determination process is set to 1.

45. The conversion block encoding method of claim 13, wherein the basic block removal reference value in the macro-block determination process is a value which is used to determine whether to remove the basic blocks within the macro-block, and is a value which is set by adding of a sum of smallest coefficient values of the applied filter to a largest coefficient value.

46. The conversion block encoding method of claim 14, wherein the basic block removal reference value in the macro-block determination process is a value which is used to determine whether to remove the basic blocks within the macro-block, and is a value which is set by adding of a sum of smallest coefficient values of the applied filter to a largest coefficient value.

47. The conversion block encoding method of claim 13, wherein the macroblock removal reference value in the macro-block determination process is set to a value obtained by adding a sum of smallest coefficients to a maximum cost for a largest coefficient (largest coefficient×2), in order to perform removal up to a case where there are two or less DC coefficients to which the largest coefficient has been applied.

48. The conversion block encoding method of claim 14, wherein the macroblock removal reference value in the macro-block determination process is set to a value obtained by adding a sum of smallest coefficients to a maximum cost for a largest coefficient (largest coefficient×2), in order to perform removal up to a case where there are two or less DC coefficients to which the largest coefficient has been applied.

49. The conversion block encoding method of claim 15, wherein the macroblock removal reference value in the macro-block determination process is set to a value obtained by adding a sum of smallest coefficients to a maximum cost for a largest coefficient (largest coefficient×2), in order to perform removal up to a case where there are two or less DC coefficients to which the largest coefficient has been applied.
